(19) United States
(12) Patent Application Publication
(10) Pub. No.: US 2008/0253016 A1
(43) Pub. Date: Oct. 16, 2008

(54) For Digital Information Adapted Memory Arrangement

(76) Inventor: Konstantinos Pyykko, Stockholm (SE)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/991,001

(22) PCT Filed: Jul. 13, 2006
(86) PCT No.: PCT/SE2006/050258

§ 371 Date: Apr. 22, 2008

(30) Foreign Application Priority Data
Jul. 13, 2005 (SE) 0501661-3

(51) Int. Cl. G11B 5/55; G11B 5/48

(52) U.S. Cl. 360/75; 360/246.6

(57) ABSTRACT

The present invention refers to a digital information adapted memory arrangement, where said arrangement includes hard disc means and one or more writing and/or reading heads, said hard disc means (1) is caused to rotate by using a driving device. Said head or heads (2. 2a) are arranged to a head or heads holding arm (3), causing said head or heads to be oriented adjacent said hard disc means (1) and arranged over (or under) said hard disc means in order to write and/or read digital information to and from said hard disc means. Said head or heads holding arm (3) is fixedly supported by or via base means (B). Said fixed holding arm (3) is arranged to extend over said disc means and that a writing and/or reading head (2, 2a) is allotted to read and/or write information related to a certain radius orientation of information (1a, 1b) related to said disc means, where RAID-technology is used for writing and/or reading data information stored along sections (1a, 1b) of a data track related to said disc (1).

### TECHNICAL FIELD OF THE INVENTION

The present invention relates generally to an arrangement in connection with writing and/or reading alternatively reading and/or writing digital information and has its general application in storing digital information on a hard disc memory means.

The present invention is more precisely related to, for any digital information adapted, a memory arrangement, where said arrangement may include a rotating hard disc means or cylinder and thereto related one or more, more practically a multitude of, writing or reading heads.

More precisely said hard disc means is in a common application caused to rotate, in a predetermined velocity or rpm, by using one or more, by a base means supported, driving devices.

Said head or heads are arranged to a head or heads holding arm, causing said head or heads to be oriented adjacent to said hard disc or cylinder means and arranged adjacent to and over alternative under said hard disc means, in order to read and/or write digital information to and from said hard disc means, and that a reading and/or writing head is allotted to read and/or write information related to a certain radius orientation of information related to said disc means.

### DESCRIPTION OF THE BACKGROUND OF THE INVENTION

Several different methods and designs of the aforesaid nature are known to the art including the content of the patent publication U.S. Pat. No. 4,152,736.

This patent publication discloses a disc file having on one side of said disc a servo track and a plurality of data tracks, all equally spaced on centres and a carriage translatable across the disc and exposing an array of read/write heads.

Some of said heads are spaced on centres for the distance equal to the spacing between adjacent ones of said tracks and others of which are spaced on centres for multiples of the distance between adjacent ones of said tracks.

The spacing between said heads being such that when said heads are successively in alignment with said servo track the other of said heads are aligned with said data tracks.

Considering the technical features related to the present invention it is to be mentioned that it is known to the art to use a RAID-system, when writing and/or reading data from and to a memory and especially a hard disc memory of a kind mentioned in the introductory part of this application.

The principles used within a RAID-system are evaluated in the publication “A Transactional Approach to Redundant Disk Array Implementation” CMU-CS-97-141.

### SUMMARY OF THE PRESENT INVENTION

### Technical Problems

When taking into consideration the technical deliberations that a person skilled in this particular art must make in order to provide a solution to one or more technical problems that he/she encounters, it will be seen that it is necessary initially to realise the measures and/or the sequence of measures that must be undertaken to this end, on the one hand, and to realise which means is/are required to solve one or more of said problems, on the other hand.

On this basis, it will be evident that the technical problems listed below are highly relevant to the development of the present invention.

In an arrangement, related to a digital information adapted memory arrangement, where said arrangement includes one or more hard disc means and related to each of these hard disc means one or more writing and/or reading heads, where said hard disc means are caused to rotate by using, by a base means supported, one or more driving devices, and where predetermined head or heads are arranged to its head or heads holding arm, causing said head or heads to be oriented adjacent said hard disc means and arranged in order to write and/or read digital information to and from said hard disc means, it must be seen as a technical problem to realise the advantageous related to, the technical problems of and/or the technical benefits related to cause said head or heads holding arm to be fixedly supported by or via said base means, that said fixed holding arm is arranged to extend over said disc means and that a reading and/or writing head is allotted to write and/or read information related to a certain radius orientation of information related to said disc means, using for this writing and/or reading a RAID-related information.

It is also a technical problem to realise the advantages related to, the technical problems associated with and/or the benefits related to one or more of the hereunder mentioned challenges;
a. High performance, high endurance with low MTBF (Mean Time Before Failure),
b. More durable by using low voltage for a reduction of heat, low rpm (Revolution per minute), high end, high quality and lesser risk of breakage.
c. Introducing a new RAID head technology, based upon standard known technology but built into HDD (Hard Disc Drive) heads.
d. Introducing a new RAID sector and/or cylinder technology, based upon sectors mirrored and controlled by IQ-chip (Intelligent chip).
e. No moving multiple head technology including no moving arms with write and/or read to avoid breakage including controller chip technology to manage bottlenecks from multiple heads and streams of data.
f. The use of security chip for HDD that makes them encrypted on removal or causing different architecture (file system in place) applied to any sort of data storing media, from RAM, disc or tape to SIM card.
g. A head RAID, a multiple of head RAID, a cylinder RAID application and a sector RAID application, wherein a used controller chip is adapted to managing N number of sectors.
h. Introducing intelligent controller chip for write and/or read heads, sectors, cylinders and data depending on chosen design, one for each device or component.
i. Introducing a HDD, adapted for a moving environments like portables, in server environments, where MTBF is more critical, in space shuttle technology where HDD can be in hard G-force and other huge environmental pressures against HW, in portable devices such as phones cameras, laptops or PDA's.
j. Introducing redundancy in case a write and/or read head breaks down it is introduced an option to read the same data on an other sector, that is mirrored on another cylinder with another write and/or read head structure and/or with another sector or cylinder.
k. Using standard RAID technology (0+1 or 1 or 5, depending on cost and design, all RAID levels supported) 4 heads 4.
l. Using sector 0+1 technology with a slow motor technology to more head(s) one step or more up or down in order to read the sector, related to the head that is broken, from another intact head related to one or more cylinders and face the fact that the more you add the more reliable the disc and cost.
m. Introducing many heads and the RAID technology the memory disc will be faster and more reliable even with a lower rpm.
n. The use of a lower voltage causing lower energy consumption (lower watt) and lower temperature it will be possible to build more reliable small factors drives, that requires less power and cooling costs.
o. Introducing two different chips, one adapted for controlling the stored information on the disc and one adapted for security, said second chip will assure that stored data is secured, regardless of a wrong person getting hold of the device.

It is a technical problem to realise the advantages related to, the technical problems associated with and/or the benefits related to a first set, including a predetermined number of head or heads, of holding arms, arranged across said hard disc means, and that each such holding arm within said set is adapted to carry one or more writing and/or reading heads.

It is a technical problem to realise the advantages related to, the technical problems associated with and/or the benefits related to a second set, including a predetermined number of head or heads, of holding arms, arranged across said hard disc means, and that each such holding arm within said set is adapted to carry one or more reading and/or writing heads.

It is a technical problem to realise the advantages related to, the technical problems associated with and/or the benefits related to said first set of holding arms and that said second set of holding arms are arranged in a perpendicular or other suitable orientation.

It is a technical problem to realise the advantages related to, the technical problems associated with and/or the benefits related to one or more head or heads holding arms, fixedly supported by or via said base means, that said fixed holding arms are arranged to extend under said disc means and that a writing and/or reading head is allotted to write and/or read information related to a certain radius orientation of information, related to said underside of said disc means.

It is a technical problem to realise the advantages related to, the technical problems associated with and/or the benefits related to a third set, including a predetermined number of head or heads, of holding arms, arranged across said hard disc means, and that each such holding arm within said set is adapted to carry one or more writing and/or reading heads.

It is a technical problem to realise the advantages related to, the technical problems associated with and/or the benefits related to a fourth set, including a predetermined number of head or heads, of holding arms, arranged across said hard disc means, and that each such holding arm within said fourth set is adapted to carry one or more reading and/or writing heads.

It is a technical problem to realise the advantages related to, the technical problems associated with and/or the benefits related to said third set of holding arms and that said fourth set of holding arms are arranged in a perpendicular orientation and/or other suitable orientation under said hard disc means.

It is a technical problem to realise the advantages related to, the technical problems associated with and/or the benefits related to that said first and/or second set, that said third and/or fourth set of holding arms are fixedly secured to and easy released from said base means.

It is a technical problem to realise the advantages related to, the technical problems associated with and/or the benefits related to that said hard disc means is fixedly secured to and easy released from its driven shaft, related to its disc driving device in the form of a motor arrangement.

### Solution

The present invention takes as its starting point the afore described known technique in an arrangement for a digital information adapted memory arrangement, where said arrangement includes a hard disc means and one or more writing and/or reading heads, said hard disc means is caused to rotate by using, of a base means supported, one or more driving devices, said head or heads are arranged to a head or heads holding arm, causing said head or heads to be oriented adjacent said hard disc means and arranged in order to write and/or read digital information to and from said hard disc means, advising that said head or heads holding arm is fixedly supported by or via said base means, that said fixed holding arm is arranged to extend over said disc means and that a writing and/or reading head is allotted to write and/or read information related to a certain radius orientation of information related to said disc means using, RAID-related information.

It is further suggested the use of a first set, including a predetermined number of head or heads, of holding arms, arranged across said hard disc means, each such holding arm is adapted to carry one or more writing and/or reading heads.

A second set, including a predetermined number of head or heads, of holding arms, arranged across said hard disc means, each such holding arm is adapted to carry one or more writing and/or reading heads.

Said first set of holding arms and said second set of holding arms are arranged in a perpendicular orientation or any other suitable orientation.

One or more head or heads holding arms are fixedly supported by or via said base means, that said fixed holding arms are arranged to extend under said disc means and that a writing and/or reading head is allotted to read and/or write information related to a certain radius orientation of information related to said underside of said disc means.

A third set, including a predetermined number of head or heads, of holding arms, arranged across said hard disc means, each such holding arm is adapted to carry one or more writing and/or reading heads.

A fourth set, including a predetermined number of head or heads, of holding arms, arranged across said hard disc means, each such holding arm is adapted to carry one or more writing and/or reading heads.

Said third set of holding arms and that said fourth set of holding arms is arranged in a perpendicular orientation or the like under said hard disc means.

Said first and/or second set of holding arms are fixedly secured to and easy released from said base means.

Said hard disc means is fixedly secured to and easy released from its driven shaft related to its disc driving device in the form of a motor arrangement.

### Advantages

Those advantages primarily afforded by the present invention and its particular characteristic features reside in the creation of conditions for providing a digital information adapted memory arrangement, where said arrangement includes a hard disc means and one or more writing and/or reading heads, said hard disc means is caused to rotate by using a driving device, said head or heads are arranged to a head or heads holding arm, causing said head or heads to be oriented adjacent said hard disc means and arranged in order to write and/or read digital information to and from said hard disc means.

In this arrangement it is suggested that said head or heads holding arm is fixedly supported by or via a base means, that said fixed holding arm is arranged to extend over said disc means and that a writing and/or reading head is allotted to write and/or read information related to a certain radius orientation of information related to said disc means, using for this writing and/or reading a RAID-related information.

The primary characteristic features of the present invention are set forth in the characterising clause of the accompanying Claim 1.

### BRIEF DESCRIPTION OF THE DRAWINGS

Known techniques and at present proposed embodiments, comprising features significant of the present invention, will now be described in more detail by way of example with reference to the accompanying drawings, in which;

FIG. 1 illustrates a disc file, as described and shown in FIG. 9 in the patent publication U.S. Pat. No. 4,152,736 as a relevant prior art construction,

FIG. 2 illustrates in a perspective overall view of a first embodiment including only one memory disc means for simplifying the illustration of the principals of the present invention,

FIG. 3 illustrates in a perspective view a second embodiment exposing the significative features related to the present invention, using one single memory disc only however, exposing digital data stored on each side or the disc and exposing the use of an upper and a lower Si-chip, each with write and/or read heads orientated in an array and/or matrix-orientation,

FIG. 4 illustrates in a plan view a third embodiment exposing the significative features related to the present invention,

FIG. 5 illustrates a side elevation view of the embodiment exposing the significative features related to the present invention as shown in FIG. 4.

FIG. 6 illustrates in a plan view a fourth embodiment exposing the significative features related to the present invention and

FIG. 7 illustrates a side elevation view the embodiment exposing significative features related to the present invention as shown in FIG. 6.

### DESCRIPTION OF THE KNOWN TECHNIQUE AS ILLUSTRATED IN THE EMBODIMENT SHOWN IN FIG. 9 IN U.S. Pat. No. 4,152,736.

As before mentioned, FIG. 9 illustrates a disc file, having on one side of said disc a servo track and a plurality of data tracks, all equally spaced on centres and a carriage translatable across the disc and having an array of read/write or write/read heads.

Some of said heads are spaced on centres for the distance equal to the spacing between adjacent ones of said tracks and others of which are spaced on centres for multiples of the distance between adjacent ones of said tracks.

The spacing between heads being such that when said heads are successively in alignment with said servo track the other of said heads are aligned with said data tracks.

In said Patent Publication there is shown and described a system for moving an array 70 across the disk 20a and includes a servo mechanism 100, servo electronics 102, a switching network 104 and a data read channel 106.

The switching network 104 is illustrated in greater detail and may be seen to include a number of switches. Some switches are connected with a magnetic head, some other switches are connected with another head and further switches are connected with still other heads.

Some switches are connected with the data read/write channel 106 and, other switches are connected with the servo electronics 102.

### DESCRIPTION OF EMBODIMENTS AT PRESENT PREFERRED AND PROPOSED

It is pointed out initially that in the following description of embodiments at present proposed and having the characteristic features of the present invention and illustrated in the figures of the accompanying drawings, we have elected to use terms and special terminology with the primary intention of illustrating the concept of the invention more clearly.

However, it will be noted that the expressions chosen here shall not be seen as being limited solely to the actual terms used in the description but that each term shall be interpreted as also including all technical equivalents that function in essentially the same way so as to achieve essentially the same intention and/or technical effect.

Thus FIG. 2 illustrates an overall view of a first embodiment of the present invention.

The embodiment illustrated in FIG. 2 makes use of one hard disc memory 1, rotating by a not shown driving means around its centre line 1′. The rpm may here be chosen to 15 000 or the like.

Said memory disc 1 is here exposing on its upper side a number of data tracks, where one has been allotted the reference numeral 1a, and a second has been allotted the reference numeral 1b. Further data tracks are also used however these data tracks have not been given any reference numeral.

One or two writing and/or reading heads 2, 2a are here coordinated to one and the same supporting bar or holding arm 3 and are coordinated for evaluating stored or entered data to one and the same data track 1a on solely one side of the disc cylinder 1.

Other supporting bars may be used for an adjacent data track 1b and thereto related writing and/or reading heads.

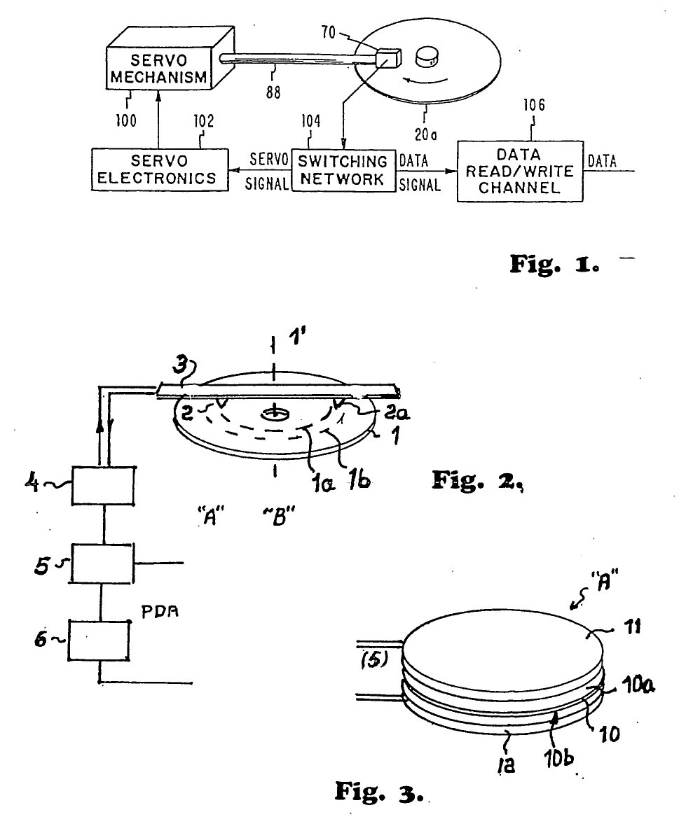

FIG. 1 thus expose, for a digital information adapted, a memory arrangement “A”, where said arrangement includes a hard disc means 1 and one or more writing and/or reading heads 2, 2a, said hard disc means 1 is caused to rotate by using, of a base means “B” supported, a related driving device.

Said head or heads 2, 2a are arranged to a head or heads holding arm 3, causing said head or heads to be oriented adjacent an upper surface of said hard disc means 1, in order to writhe and/or read digital information to and from said hard disc means 1.

Said head or heads 2, 2a are coordinated with a means 4 adapted to evaluate the position of said heads 2, 2a in relation to the disc 1 and its data track 1a.

To said write and/or read heads 2, 2a is, by a communication link, connected means 4, said means 4 also includes circuits and functions related to RAID-system or -chip, and as such evaluates where one and the same coordinated and correspondding data information is stored and mirrored.

Thus means 4 evaluates the actual position of related writing and/or reading 2, 2a and the position along the data track 1a, (1b) on the disc 1.

Moreover said means 4 is in FIG. 2 illustrated to be adapted to cooperate with an interface 5.

Said interface 5 may be of a standardised construction, such as a dual interface, preferably such as SCSI, SAS, SATA or other interface standards.

This interface 5 is further illustrated as related to a digital information processing device 6.

Said device 6 may be a camera, a mobile telephone device, a PC or other similar devices exposing larger or smaller outer dimensions.

FIG. 3 is intended to illustrate a hard disc arrangement “A” where the memory disc 10 is formed to expose data tracks on each side 10a, 10b thereof and where a first head supported disc 11 is arranged to cover the over the upper side 10a and a head supporting disc 12 is arranged to cover the lower (under) side 10b thereof.

Each of those discs 11 and 12 may be in the form of a chip, supporting not only the heads as such but also circuitries and functions related to said head, which means that some circuits and some functions, in FIG. 2 related to said means 4, may here be integrated within said chip 11 and 12.

Further FIG. 3 illustrates that the chips 11 and 12 are fixed in relation to the hard disc memory chip 10 however said chips 11 and 12 may be displaced simultaneously and/or separately in relation to chip 10.

Such a displacement must carefully recognize that each of or at least selected heads 2, 2a must be capable to write and/or read data information from related and relatively and physically displaced data tracks 1a, 1b.

As well the embodiment illustrated in FIG. 2 as the embodiment illustrated in FIG. 3 are exposing the arrangement “A” where said head or heads holding arm 3 is fixedly supported by or via said base means B, that said fixed holding arm 3 is arranged to extend over said disc means 1 and that a writing and/or reading head is allotted to read and/or write information, related to a certain radius orientation of information (sections) related to said disc means or cylinder here using appropriate RAID-related information.

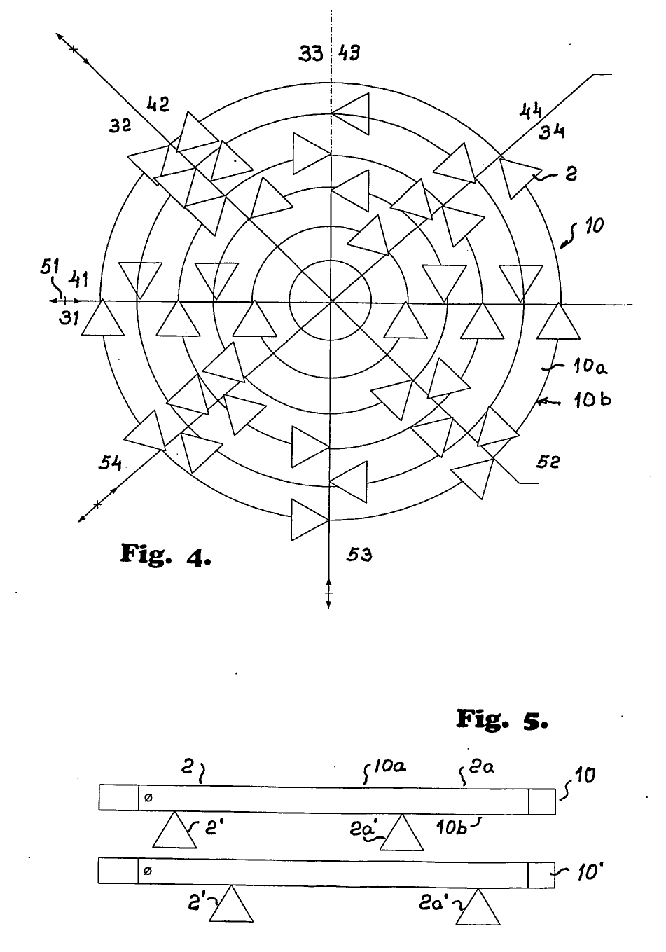

FIGS. 4 and 5 do illustrate a suggested distribution of a number of heads related in four diameter related rows 41, 42, 43, and 44, where the heads are related to its holding arm (not shown) however clearly indicated as lines.

Here used write or read alternatively write and/or read heads are shown in the form of triangular signs, where some few have been allotted the reference numeral 2 and 2a for coordinated and writing and reading identical data information as in FIG. 2.

Thus it is here illustrated a first set, including a predetermined number of head or heads, of holding arms 31, 32. 33 and 34, each arranged diametrically across said hard disc means 10, and each such holding arm, within said set, is adapted to carry one or more writing or reading alternatively reading and/or writing heads, here related in its row or line.

The distribution of the heads, shown in FIG. 4, are related to the upper surface 10a of the disc 10.

The lines 51, 52, 53 and 54 are connected to an intelligent chip arrangement 4 and via an interface 5 to a computer device 6 with standard connectors, doubled or single.

A second set, including a predetermined number of head or heads, of holding arms, arranged across said hard disc means 10 on the under side 10b thereof and each such holding arm is adapted to carry one or more writing or reading alternatively writing and/or reading heads, referenced 2′ and 2a′.

Said second set of holding arms are covered by the disc 10 in FIG. 4.

Heads on each side of the disc 10 and/or data tracks may contain the same data information depending upon the configuration related to RAID-structure on the same disc side 10a alternatively the same data information may occur on the position on side 10b or another positions on other discs.

The information stored is to be mirrored at one or more positions related to the data disc and or data track.

Said first set of upper holding arms and said second set of lower holding arms are arranged in a perpendicular orientation.

One or more head or heads holding arms are fixedly supported by or via said base means B, that said fixed holding arms are arranged to extend over and under said disc means 10 and that a writing and/or reading head is allotted to write and/or read information related to a certain radius orientation of information related to said over side or underside of said disc means 10.

FIG. 5 is intended to illustrate the use of two disc means or cylinders 10, 10%, arranged adjacent to each other and the lower disc arrangement 10′ may include writing and/or reading heads distributed as shown for the upper disc 10.

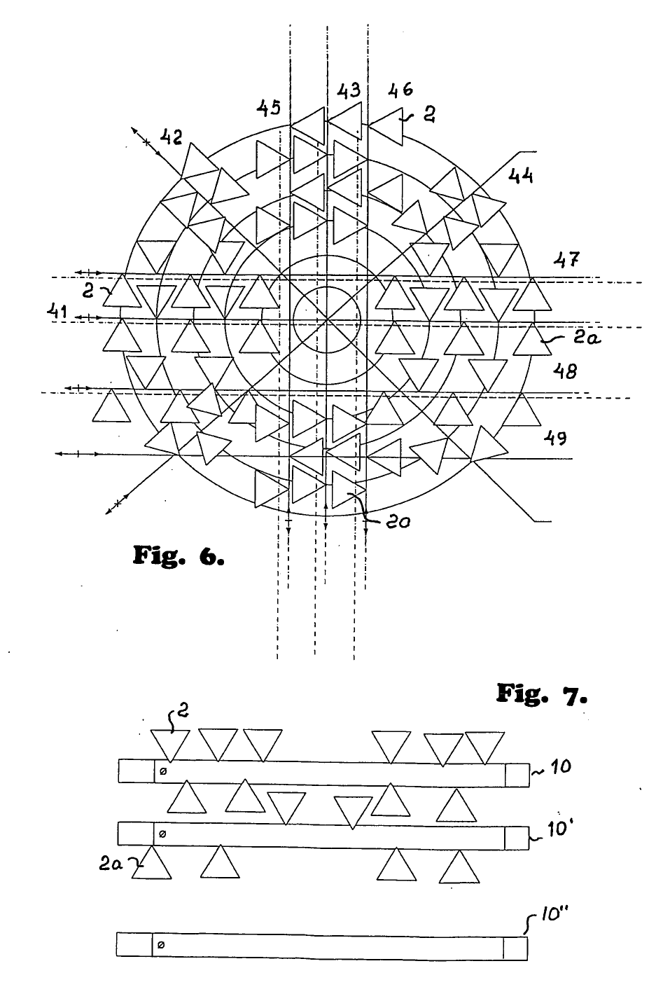

FIGS. 6 and 7 illustrate an alternative of arranging the holding arms and its heads.

The suggested distribution of a number of heads related to four diameter related rows 41, 42, 43, 44 as in FIG. 4 but there is also a number of corda related rows as illustrated by the reference numerals 45, 46, 47, 48 and 49.

FIG. 7 also illustrates the use of two hard disc memories 10, 10′, as in FIG. 5 however it is suggested the use of a number of additional disc means, where one has been allotted the reference numeral 10″.

Also in this application the heads are connected to intelligent RAID-chip 4 that keeps index of data and RAID-level related to every diagonal holding arm with associated heads.

The FIG. 6 illustration exposes an array of and heads 2 oriented diagonally, vertically and/or in any other chosen direction, especially forming said matrix and or array structure.

Said heads are related to its data track and its data sector where at least one, two or more write and/or read heads per sector are depending upon chosen RAID-level and the number of discs and heads and the number of mirrored information.

Heads on each side of a disc and/or each side of a chosen number of discs and its data sectors may contain a fraction of the same data information, depending upon a chosen RAID-configuration, where a head related to disc 10 may write or read the same data information on the same position on disc 10′ and/or disc 10″. Said information is said to be mirrored.

This causes a required redundancy.

A third set, including a predetermined number of head or heads, of holding arms, in FIG. 6 similar to what has been shown as first and second sets, are arranged across said hard disc means, and each such holding arm is adapted to carry one or more writing and/or reading heads.

A fourth set, including a predetermined number of head or heads holding arms, is arranged, in a matrix formation, across said hard disc means and that each such holding arm is adapted to carry one or more reading and/or writing heads.

Said third set of holding arms and that said fourth set of holding arms are arranged in a perpendicular orientation, or any suitable orientation, over or under said hard disc means.

Said first and/or second set of holding arms are fixedly secured to and easy released from said base means B.

Said hard disc means is fixedly secured to and easy released from its driven shaft related to one or more disc driving devices in the form of one or more motor arrangements.

Every hard disc drive (HDD) related write/read head is connected to a solid arm or a matrix of or an array of arms that is connected to its chip. That controls data In/Out via said interface 5 that also have a HW/SW chip 4 (Hard Ware/Soft Ware), said chip 4 contains separated information, where said heads 2, 2a may be connected to each other, by which used RAID-level so performed and available will make this design unique.

The heads could of course be placed on transparent plastic film, Si- or other in use preferred materials, or disc, with matrix or arrays of heads easily to put over a disc cylinder with standard sizes for different discs with different number of heads for different cost and performance and availability, which of course is connected to the chips that control places of data; which head, cylinder and sector.

The drives will use to day standards in connecting to and from the used interface, such as SCSI, IDE, SATA SAS (double or single).

The RAID related SW/FW on chips will be of to day standard.

This network/array of built in RAID technology with lesser or no moving parts specially in regards of fast moving arms with high 15 000 rpm spinning disc will thanks to this new revolutionary design with all intelligence that to day High End solutions have in different separate parts in larger server environments be available in now not only client environments but the hole range of products from PDA (Personal Device Application) to High End Server environments using digital processing devices.

This will cover matrix and/or arrays of heads no matter how they are placed and orientated over or under the cylinder, such as in zigzag patterns, diagonally, horizontally, randomly (=many heads/write/read) at least one or more for each sector on drive.

It will be noted in particular that each illustrated unit can be combined with each other illustrated unit within the framework of achieving a desired technical function.

1. For digital information adapted memory arrangement, where said arrangement includes a hard disc means and one or more writing or reading alternatively writing and/or reading heads, said hard disc means is caused to rotate by using a driving device, said head or heads are arranged to a head or heads holding arm, causing said head or heads to be oriented adjacent said hard disc means and in order to write and/or read digital information to and from said hard disc means, wherein said head or heads holding arm is fixedly supported by or via a base means, said fixed holding arm is arranged to extend over said disc means, and a head is allotted to write and/or read information, related to a certain radius orientation of information, related to said disc means, using a RAID-related information.

2. Memory arrangement as claimed in claim 1, including a first set, including a predetermined number of head or heads, of holding arms, arranged across said hard disc means, where each such holding arm is adapted to carry one or more sets of writing and/or reading heads.

3. Memory arrangement as claimed in claim 2, including a second set, including a predetermined number of head or heads, of holding arms, arranged across said hard disc means, where each such holding arm is adapted to carry one or more writing and/or reading heads.

4. Memory arrangement as claimed in claim 3, wherein said first set of holding arms and said second set of holding arms are arranged in a perpendicular orientation.

5. Memory arrangement as claimed in claim 1, wherein one or more head or heads holding arms are fixedly supported by or via said base means, said fixed holding arms are arranged to extend under said disc means, and a head is allotted to write and/or read information related to a certain radius orientation of information related to said underside of said disc means.

6. Memory arrangement as claimed in claim 5, including a third set, including a predetermined number of head or heads, of holding arms, arranged across said hard disc means, where each such holding arm is adapted to carry one or more reading and/or writing heads.

7. Memory arrangement as claimed in claim 6, including a fourth set, including a predetermined number of head or heads, of holding arms, arranged across said hard disc means, where each such holding arm is adapted to carry one or more reading and/or writing heads.

8. Memory arrangement as claimed in claim 6, wherein said third set of holding arms and that said fourth set of holding arms are arranged in a perpendicular under said hard disc means.

9. Memory arrangement as claimed in claim 8, wherein said first and/or second set of holding arms are fixedly secured to and easily released from said base means.

10. Memory arrangement as claimed in claim 9, wherein said hard disc means is fixedly secured to and easy released from its driven shaft, related to a disc driving device, in the form of a motor arrangement.
